(19) United States
(12) Patent Application Publication
(10) Pub. No.: US 2022/0003091 A1
(43) Pub. Date: Jan. 6, 2022

(54) FLOWLINE DEWATERING

(71) Applicant: ONESUBSEA IP UK LIMITED, London (GB)

(72) Inventors: Hans Fredrik Kjellnes, NESTTUN (NO); Ina Ekeberg, Sandsli (NO); Svein-Arne Marthinussen, Sandsli (NO); Helge Dale, Raadal (NO); Knut Klepsvik, Sandsli (NO); Per Bloch Helmers, Sandsli (NO)

(21) Appl. No.: 17/366,312

(22) Filed: Jul. 2, 2021

Related U.S. Application Data
(60) Provisional application No. 63/047,592, filed on Jul. 2, 2020.

(51) Int. Cl. E21B 43/12; E21B 43/01

(52) U.S. Cl. CPC E21B 43/13; E21B 43/01

(57) ABSTRACT

A flowline dewatering system comprising at least one pump and a pig train supported by a gas pressure enabling suction conditions for the pump. A method to dewater a flowline using the system.

### BACKGROUND

For subsea applications, hydrocarbon fluids such as oil and natural gas are obtained from a subterranean geologic formation, referred to as a reservoir, by drilling a well through a subsea wellhead system that penetrates the hydrocarbon-bearing geologic formation. In subsea applications, various types of infrastructure may be positioned along a sea floor and coupled by flow lines. The flow lines enable flow of production fluids, e.g. oil, gas, or other types of production fluids, from one subsea installation to another. Flow lines also may extend upwardly to various types of surface facilities, such as surface vessels or platforms.

Upon commissioning of a gas flowline, a known method to dewater is to insert a pig train in the far end of the water flooded flowline. A gas line from shoreside or vessel compression facility is connected to the far end of the flowline. Then compressed gas, typically nitrogen, is driving a pig train from subsea and back to shore. The gas pressure has to be slightly higher than that of the ambient seawater pressure to drive the pig towards shore. For deepwater flowlines that can mean a requirement of 2-300 bars which governs a requirement for an extensive compression plant due to the large pressure ratio. This process might be cumbersome, expensive and time consuming.

As the market for offshore gas is picking up, an increased amount of such flowlines is expected. Hence, the operators are looking for more efficient ways to execute this operation.

### SUMMARY

This summary is provided to introduce a selection of concepts that are further described below in the detailed description. This summary is not intended to identify key or essential features of the claimed subject matter, nor is it intended to be used as an aid in determining or limiting the scope of the claimed subject matter as set forth in the claims.

In embodiments of the disclosure, it is proposed a flowline dewatering system comprising at least one pump and a pig train supported by a gas pressure enabling suction conditions for the pump. In embodiments, the at least one pump is a multiphase pump.

In embodiments of the disclosure, the system further comprises a meter for density detection to estimate Gas Volume Fraction. In embodiments of the disclosure, the system further comprises a second pump.

In embodiments of the disclosure, it is further proposed a method to dewater a flowline, comprising providing a flowline dewatering system comprising at last one pump and a pig train supported by a gas pressure enabling suction conditions for the pump. In embodiments, the pig train is launched from sea topside. In embodiments, the gas flowline extends from shore to subsea.

### BRIEF DESCRIPTION OF THE DRAWINGS

For a detailed description of exemplary embodiments, reference will now be made to the accompanying drawings in which:

FIG. 1 represents a flowline dewatering system according to embodiments of the disclosure;

FIG. 2 represents a flowline dewatering system according to other embodiments of the disclosure.

### DETAILED DESCRIPTION

In the drawings and description that follow, like parts are typically marked throughout the specification and drawings with the same reference numerals. The drawing figures are not necessarily to scale. Certain features of the disclosed embodiments may be shown exaggerated in scale or in somewhat schematic form and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure and is not intended to limit the disclosure to that illustrated and described herein. It is to be fully recognized that the different teachings of the embodiments discussed below may be employed separately or in any suitable combination to produce desired results.

Unless otherwise specified, in the following discussion and in the claims, the terms “including” and “comprising” are used in an open-ended fashion, and thus should be interpreted to mean “including, but not limited to . . . ”. Any use of any form of the terms “connect”, “engage”, “couple”, “attach”, or any other term describing an interaction between elements is not meant to limit the interaction to direct interaction between the elements and may also include indirect interaction between the elements described. The various characteristics mentioned above, as well as other features and characteristics described in more detail below, will be readily apparent to those skilled in the art upon reading the following detailed description of the embodiments, and by referring to the accompanying drawings.

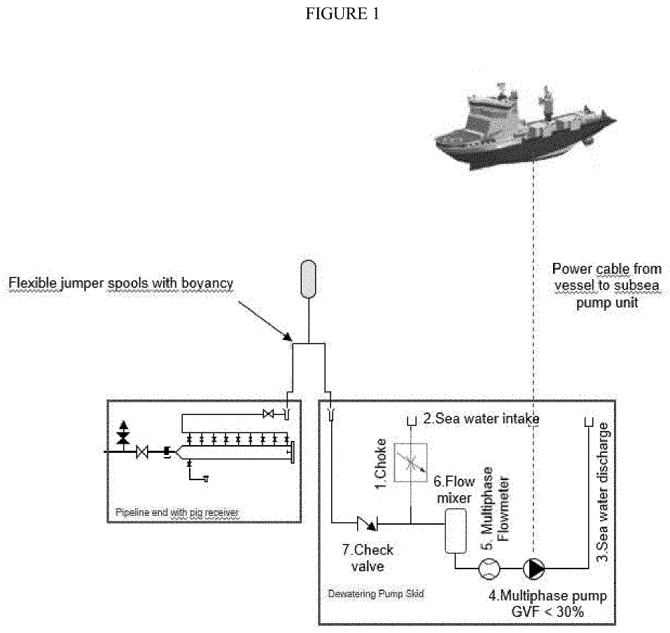

With the foregoing in mind, turning now to the present, FIG. 1 is an embodiment of a flowline dewatering system according to the disclosure for example in medium water depth. A pump might be powered from a vessel.

The Pump 4 might be started with a fully open sea water intake choke 1. As the desired speed is reached and the intake choke 1 is throttled down, the pump will start to draw down pressure on the suction side. The inlet check valve 7 will crack open and the dewatering process starts.

As a certain amount of gas will leak across the pig train, some gas is to be expected through the pump 4. A multiphase flowmeter 5 or another device for density detection might be used to estimate Gas Volume Fraction (GVF). When the GVF exceeds the maximum acceptable for the pump, the intake choke 1 will start to let seawater into the suction side. Hence, the pump 4 will be able to generate a differential pressure enabling to dewater the flowline, even when high gas content is to be evacuated towards the end of the dewatering process.

The system of the disclosure is thus very compact and might be installed on a temporary structure. In embodiments, the dewatering might be a continuous operation with no need for cyclic operation to evacuate gas from separators. This way, dewatering of such flowlines can be done with less topside compression power, more energy efficiency and potentially be faster and safer. The final gas pressure in the flowline will be lower as well, which will ease the subsequent de-pressurizing.

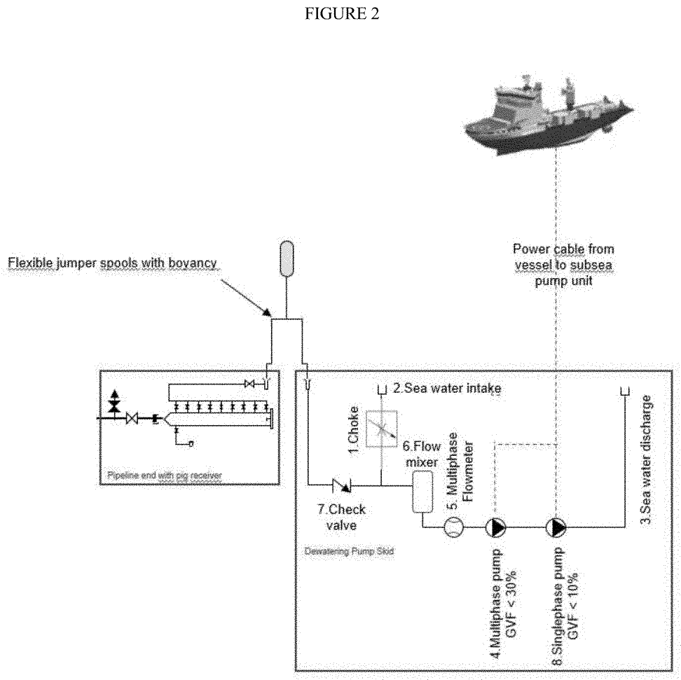

FIG. 2 is an embodiment of flowline dewatering system according to the disclosure for example in high water depth. A pump skid comprising a multiphase pump might be used to dewater a gas flowline from shore to the far end of said flowline A pig train is launched from topsides and might be supported by a gas pressure enabling suction conditions for the pump.

In embodiments, pumps might be powered from a vessel. In embodiments wherein pumping is occurring at the differential pressures required when water depths exceed 1500 to 2000 meters, a booster stage might be added to the multiphase pump. The multiphase pump will compress the associated gas.

In embodiments, pump 4 and 8 might be started with a fully open sea water intake choke 1. As the desired speed is reached and the intake choke 1 is throttled down, the pump will start to draw down pressure on the suction side. The inlet check valve 7 will crack open and the dewatering process starts.

As a certain amount of gas will leak across the pig train, some gas is to be expected through the pump 4. A multiphase flowmeter 5 or another device for density detection is used to estimate GVF. When the GVF exceeds the maximum acceptable for the pump, the intake choke 1 will start to let seawater into the suction side. Hence, the pump 4 will be able to generate a differential pressure to dewater the flowline, even when high gas content is to be evacuated towards the end of the dewatering process.

The above discussion is meant to be illustrative of the principles and various embodiments of the present disclosure. While certain embodiments have been shown and described, modifications thereof can be made by one skilled in the art without departing from the spirit and teachings of the disclosure. The embodiments described herein are exemplary only and are not limiting. Accordingly, the scope of protection is not limited by the description set out above, but is only limited by the claims which follow, that scope including all equivalents of the subject matter of the claims.

What is claimed is:

1. A flowline dewatering system comprising at least one pump and a pig train supported by a gas pressure enabling suction conditions for the pump.

2. The flowline dewatering system of claim 1, wherein the at least one pump is a multiphase pump.

3. The flowline dewatering system of claim 1, further comprising a meter for density detection to estimate Gas Volume Fraction.

4. The flowline dewatering system of claim 1, further comprising a second pump.

5. A method to dewater a flowline, comprising providing a flowline dewatering system comprising at last one pump and a pig train supported by a gas pressure enabling suction conditions for the pump

6. The method to dewater a flowline of claim 5, wherein the pig train is launched from sea topside.

7. The method to dewater a flowline of claim 5, wherein the gas flowline extends from shore to subsea.
